(19) United States
(12) Patent Application Publication
(10) Pub. No.: US 2016/0189464 A1
(43) Pub. Date: Jun. 30, 2016

(54) BILL HANDLING SYSTEM, BILL HANDLING APPARATUS, AND BILL HANDLING METHOD

(71) Applicant: GLORY LTD., Hyogo (JP)

(72) Inventor: Yoshikatsu MIZUSHIMA, Hyogo (JP)

(73) Assignee: GLORY LTD., Himeji-shi, Hyogo (JP)

(21) Appl. No.: 14/907,997

(22) PCT Filed: Jul. 31, 2013
(86) PCT No.: PCT/JP2013/004645

§ 371 Date: Jan. 27, 2016

(51) Int. Cl. G07D 11/00; G06K 9/18; G06K 9/20; G06K 9/34

(52) U.S. Cl. CPC G07D 11/0051; G06K 9/342; G06K 9/344; G06K 9/18; G06K 9/2081

(57) ABSTRACT

A banknote handling system includes: a full image obtaining unit configured to obtain a full image of the banknote being transported by a transport unit; and an image processing unit configured to process the full image obtained by the full image obtaining unit to generate at least one processed image smaller in data size than the full image. The banknote handling system further includes: an option presentation unit configured to present a user with a plurality of options and allow the user to select one of the plurality of options, the options including the full image and the at least one processed image; and a storage unit configured to store an image related to the option selected by the user from the plurality of options presented by the option presentation unit.

### TECHNICAL FIELD

The present disclosure relates to a banknote handling system, a banknote handling apparatus, and a banknote handling method.

### BACKGROUND ART

Patent Documents 1 and 2 disclose banknote handling apparatuses which recognize the serial number of each banknote and store the recognized serial number. Specifically, during the transportation of banknotes, these banknote handling apparatuses obtain a full image of each of those banknotes using a line sensor, determine, based on a result of recognition of the banknote, where on the banknote the serial number is printed, and crop, out of the image thus obtained, an area in which the serial number is printed (i.e., an area image). Then, the banknote handling apparatuses crop a segment image out of the area image on a character-by-character basis, generate a binarized image out of the segment image, and recognize each character, thereby getting the serial number. The serial number thus gotten is stored and saved in a storage unit. In particular, the banknote depositing machine disclosed in Patent Document 2 stores the serial numbers in association with the customers in deposit transactions.

Patent Document 3 discloses a banknote handling apparatus which recognizes the serial number of each banknote and stores the serial number recognized. Specifically, the banknote handling apparatus stores only the serial number if the serial number has been recognized normally (e.g., all the digits of the serial number have been read successfully) and if no abnormality has been detected in the banknote. On the other hand, the apparatus stores, in association with the serial number, a full image of the banknote obtained in order to recognize the serial number if the serial number has not been recognized normally (e.g., not all the digits of the serial number have been read successfully) or if any abnormality has been detected in the banknote (e.g., scribbles or any other handwritten traces have been sensed on the banknote). In this manner, the banknote handling apparatus can meet the customer's needs appropriately after a transaction while saving its storage capacity as much as possible and reducing processing load.

### CITATION LIST

### Patent Document

PATENT DOCUMENT 1: Japanese Unexamined Patent Publication No. H10-154256

PATENT DOCUMENT 2: Japanese Patent No. 4315244

PATENT DOCUMENT 3: Japanese Unexamined Patent Publication No. 2012-18534

### SUMMARY OF THE INVENTION

### Technical Problem

As described in PATENT DOCUMENT 3 cited above, storing and saving images of banknotes are worthwhile when the images are used for meeting the customer's needs after transactions, for example. However, the size of image data, among other things that of full images, is so large that a storage unit to save the images needs to have a huge storage capacity, which is not beneficial.

On the other hand, as described in Patent Documents 1 and 2, the recognition of a serial number involves generating multiple processed images including an area image and a binarized segment image. The area image represents an area having the printed serial number, and cropped, through processing, out of a full image of a banknote obtained by using a line sensor. The segment image represents a segment that has been cropped out of the area image on a character-by-character basis and binarized. These processed images are smaller in data size than a full image, and may be used effectively when the serial number is to be double-checked after a transaction.

Hence, the user of such a banknote handling apparatus will find it necessary to select and save images they need with various factors, including the capacity of the storage unit, the transaction processing time, and the customer's needs, taken into account comprehensively. However, conventional banknote handling apparatuses cannot flexibly deal with those user's requests for the selection.

In view of the foregoing, it is therefore an object of the present disclosure to allow the user of a banknote handling system or apparatus, configured to obtain an image of a banknote and process the image, to determine flexibly the kind of an image to store.

### Solution to the Problem

Specifically, a technique according to the present disclosure relates to a banknote handling system. This banknote handling system comprises: a banknote handling system comprising: a transport unit configured to transport a banknote one by one; a full image obtaining unit configured to obtain a full image of the banknote being transported by the transport unit; an image processing unit configured to process the full image obtained by the full image obtaining unit to generate at least one processed image smaller in data size than the full image; an option presentation unit configured to present a user with a plurality of options and allow the user to select one of the plurality of options, the options including the full image and the at least one processed image; and a storage unit configured to store an image related to the option selected by the user from the plurality of options presented by the option presentation unit

In this configuration, the full image obtaining unit obtains a full image of each of the banknotes being transported by the transport unit. The full image has a relatively large data size.

The image processing unit processes the full image to generate at least one processed image with a relatively small data size.

The option presentation unit presents a user with a plurality of options and allows the user to select one of the options. The options include the full image and the at least one processed image. Specifically, for example, the system may be configured to allow the user to select his or her desired option from a plurality of options by displaying, on a display unit, the plurality of options and by letting the user operate an operation unit. In this case, the user may select, from the plurality of options, either only one option exclusively or two or more options in any arbitrary combination.

The storage unit stores an image related to the option selected by the user. Thus, the user may selectively store and save, in the storage unit, his or her desired image from the full image of the banknote and the at least one processed image. Hence, the banknote handling system with this configuration may flexibly handle the user's requests.

The image processing unit may include at least: an area image generation unit configured to generate an area image cropped out of the full image of the banknote and representing an area of the banknote on which a serial number is printed; and a binarized segment image generation unit configured to generate binarized segment images by cropping segments representing characters included in the serial number on a character-by-character basis and by binarizing the segments. The banknote handling system may further comprise an option setting unit configured to set the plurality of options selected from the full image, the area image, and the binarized segment images, and the option presentation unit may present the user with the plurality of options set by the option setting unit.

In this configuration, the image processing unit generates at least: an area image cropped out to represent an area on which the serial number is printed; and segment images obtained by cropping segments representing characters included in the serial number on a character-by-character basis and by binarizing the segments. In this manner, at least three kinds of images including the full image (i.e., the full image, the area image, and the binarized segment images) are obtained.

The image processing unit may further include a binarized area image generation unit configured to binarize the area image. In this case, four kinds of images including the full image (i.e., the full image, the grayscale area image, the binarized area image, and the binarized segment images) are obtained.

The binarized segment image generation unit may crop the binarized segment images out of the binarized area image. Then, the segment images may be accurately and easily cropped.

The image processing unit may further generate grayscale segment images. In that case, five kinds of images including the full image (i.e., the full image, the grayscale area image, the binarized area image, the grayscale segment images, and the binarized segment images) are obtained.

Note that the area image may be generated by cropping an area having the serial number printed thereon out of the full image. Moreover, as described before, the segment images may each be generated by cropping a segment out of the area image on a character-by-character basis. Alternatively, the segment images may also be generated based on the full image.

The option setting unit sets the options from a plurality of kinds (three to five kinds in the example described above) of images obtained and generated. The plurality of options may be set in any arbitrary manner. All of the three to five kinds of obtained images may be set as the options. Alternatively, two, three, or four kinds of those images may also be set as the options.

Presented with the plurality of options set in such a manner, the user is allowed to select his or her desire one of the options presented and store his or her desired kind of image. If the plurality of kinds of images are all set as the options, such a choice increases the number of the options for the user to select one from. Meanwhile, if the set options are fewer than the plurality of kinds of images, such a choice enables the user to facilitate his or her selection and improves the handiness of the banknote handling system.

The banknote handling system may further include an optical character recognition (OCR) processing unit configured to perform OCR processing on the binarized segment images to get the serial number, wherein the storage unit may store the serial number in association with the image related to the option selected by the user.

Since the storage unit stores the serial number, recognized by the OCR processing unit, in association with the selected image, the user may later check, with reference to the stored image, whether or not the recognized serial number is correct.

The banknote handling system may further comprise an output unit configured to output the image related to the option selected by the user from the plurality of options presented by the option presentation unit

The output unit may output the image to a printer, for example. In this manner, the image selected by the user may be printed on a storage medium (e.g., paper). Alternatively, the output unit may output the image to an external device (e.g., a server) which is connected to the output unit either via a cable or wirelessly and provided at least with the storage unit. In this manner, the image selected by the user may be stored and saved in the external device. The output unit allows for saving banknote-related images in various forms.

The transport unit may sequentially transport a plurality of banknotes, an output unit may output the image either during, or after, the transportation of the plurality of banknotes, and the banknote handling system may further comprise an output setting unit configured to allow the user to set timing of the output of the output unit.

If an image is further output while full images of the plurality of banknotes are being obtained and processed images are being generated with the banknotes sequentially transported, the processing load on the banknote handling system could increase particularly when the image to be output by the output unit is large in data size. The output setting unit allows the user to decide whether he or she wants the image to be output during, or after, the transportation of the banknotes. This enables outputting the image while reducing the processing load on the banknote handling system.

The storage unit may be configured to be detachable from and attachable to a body of the banknote handling system including at least the transport unit and the full image obtaining unit. This allows for replacing the storage unit with another one when the storage capacity of the former storage unit runs out with the storage of image data. The storage unit may be configured as, for example, a hard disk drive having a magnetic disk, a solid state drive (SSD) having a flash memory, or any of various memory cards such as a secure digital (SD) card. Note that the storage unit may be built in the body of the banknote handling system.

The full image obtaining unit may be capable of changing a tone level of the full image to be obtained, and the banknote handling system may further comprise a tone level setting unit configured to allow the user to set the tone level of the full image.

If the tone level of a full image is decreased, not only the full image but also a processed image generated based on the full image will have a smaller data size. Consequently, by allowing the user to set the tone level of the full image via the tone level setting unit, the storage capacity of the storage unit may be saved while the user obtains and generates an image having any desired tone level.

The area image generation unit may be capable of changing a tone level of the area image to be generated, and the banknote handling system may further comprise a tone level setting unit configured to allow the user to set the tone level of the area image.

As described above, if the tone level of an area image is decreased, the area image will have a smaller data size. Consequently, by allowing the user to set the tone level of the area image via the tone level setting unit, the storage capacity of the storage unit may be saved while the user obtains and generates an image having any desired tone level.

A technique according to the present disclosure relates to a banknote handling apparatus. The banknote handling apparatus comprises: a transport unit configured to transport a banknote one by one; a full image obtaining unit configured to obtain a full image of the banknote being transported by the transport unit; an image processing unit configured to process the full image obtained by the full image obtaining unit to generate at least one processed image smaller in data size than the full image; an option presentation unit configured to present a user with a plurality of options and allow the user to select one of the plurality of options, the options including the full image and the at least one processed image; a storage unit configured to store an image related to the option selected by the user from the plurality of options presented by the option presentation unit; and a housing configured to house at least the transport unit, the full image obtaining unit, the image processing unit, and the option presentation unit.

Furthermore, a technique according to the present disclosure relates to a banknote handling method. The banknote handling method comprises transporting a banknote one by one; obtaining a full image of the banknote being transported; processing the full image obtained to generate at least one processed image smaller in data size than the full image; presenting a user with a plurality of options and allowing the user to select one from the options before, during, or after transporting the banknote, the options including the full image and the at least one processed image; and storing an image related to the option selected by the user from the plurality of options.

### Advantages of the Invention

As can be seen from the foregoing, the banknote handling system, banknote handling apparatus, and banknote handling method allow a user to store and save his or her desired kind of image by selecting one from a plurality of kinds of banknote-related images.

### BRIEF DESCRIPTION OF THE DRAWINGS

FIG. 1 is a view illustrating the appearance of a banknote handling apparatus.

FIG. 2 illustrates a general configuration for the banknote handling apparatus.

FIG. 3 illustrates a general configuration for bundling stackers and a bundling unit.

FIG. 4 is a block diagram illustrating a general configuration for the banknote handling apparatus.

FIG. 5 is a block diagram illustrating a configuration for a banknote handling system including the banknote handling apparatus.

FIG. 6 illustrates, in comparison, a fully-captured image, a partially-captured image, and a binarized image.

FIG. 7 is an exemplary on-screen image displayed on a touch panel of the banknote handling apparatus.

FIG. 8 illustrates partially how the on-screen image changes when the kinds of images to be saved are set.

FIG. 9 illustrates partially how the on-screen image changes when the kinds of the images to be saved are set.

FIG. 10 illustrates how the on-screen image changes when image printing options are set.

### DESCRIPTION OF EMBODIMENTS

Embodiments will be described in detail below with reference to the drawings.

<General Configuration for Banknote Handling Apparatus>

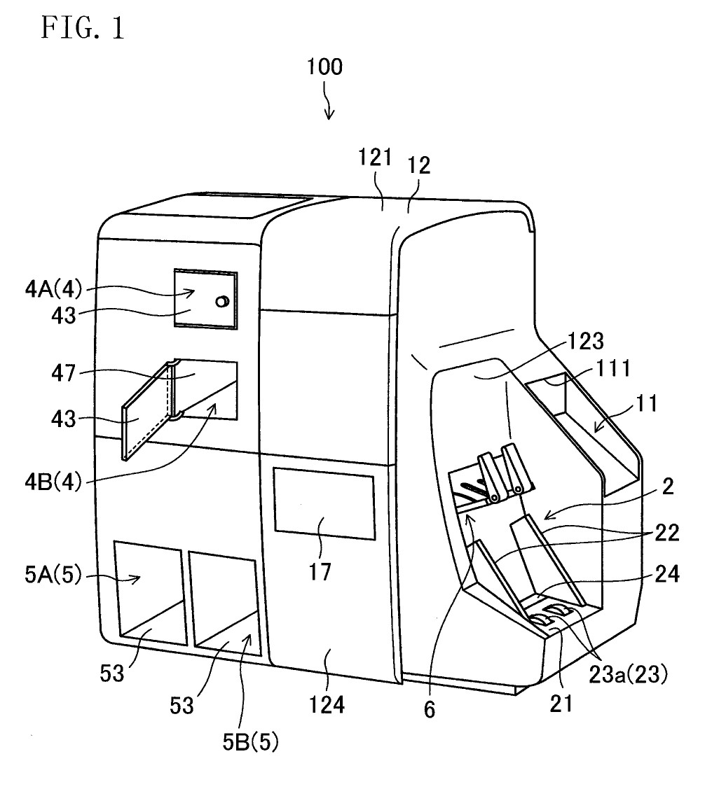

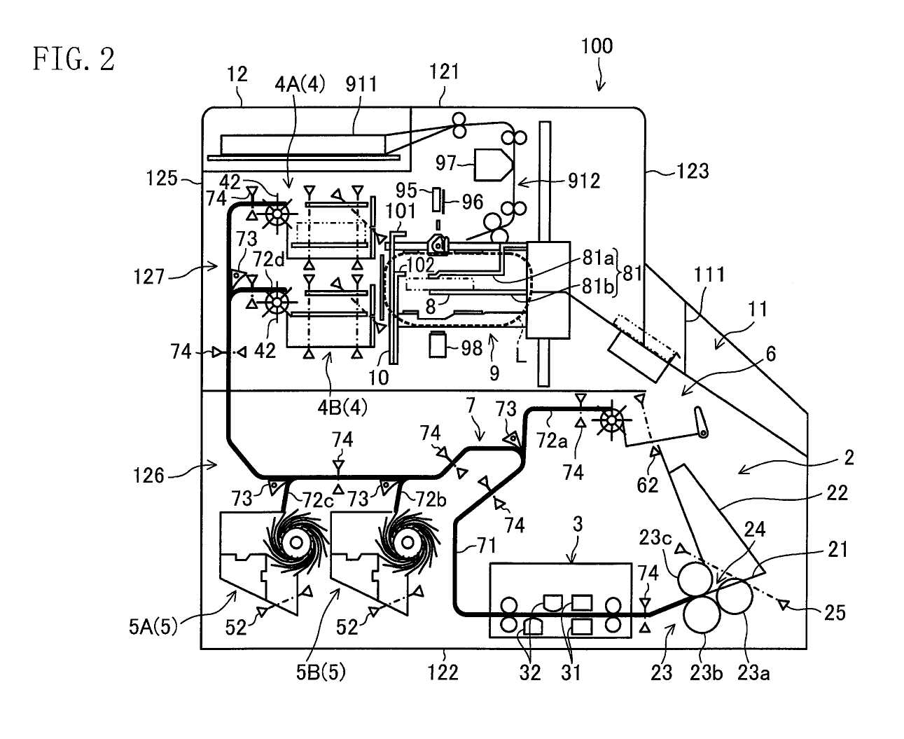

FIG. 1 illustrates the appearance of a banknote handling apparatus 100, and FIG. 2 illustrates a general configuration for the banknote handling apparatus 100.

The banknote handling apparatus 100 is placed on a teller counter of a bank, for example, and is used by an operator. The banknote handling apparatus 100 takes loose banknotes therein, stacks the banknotes of a predetermined kind, bundles the banknotes in a predetermined bundling number, and dispenses the bundled banknotes.

The banknote handling apparatus 100 includes a hopper unit 2 which takes the banknotes placed thereon into the apparatus, a recognition unit 3 which recognizes the banknotes, bundling stackers 4 which stack the banknotes to be bundled, non-bundling stackers 5 which stack the banknotes not to be bundled, a reject stacker 6 which stacks rejected banknotes, a first transport unit 7 which transports the banknotes taken in through the hopper unit 2 to the recognition unit 3, the bundling stackers 4, the non-bundling stackers 5, and the reject stacker 6, a second transport unit 8 which transports the banknotes stacked in the bundling stackers 4 to the predetermined position, a bundling unit 9 which bundles the banknotes transported by the second transport unit 8, a third transport unit 10 which transports the banknotes that have been bundled (hereinafter referred to as “bundled banknotes”), a dispense unit 11 through which the bundled banknotes are dispensed, and a box-shaped housing 12 which houses the recognition unit 3, the bundling stackers 4, the non-bundling stackers 5, the reject stacker 6, the first transport unit 7, the second transport unit 8, and the bundling unit 9, and the third transport unit 10.

The housing 12 has a top surface 121, a bottom surface 122, and four side surfaces. The housing 12 is a desktop type housing. That is to say, the bottom surface 122 of the housing 12 is not provided with casters or any other similar parts, and thus the housing 12 is configured to be placed on the desk.

The hopper unit 2 and the dispense unit 11 are provided through a first side surface 123, which is one of the four side surfaces of the housing 12. First outlets 47 of the bundling stackers 4 and second outlets 53 of the non-bundling stackers 5, which will be described in detail later, are provided through a second side surface 124, which is another one of the four side surfaces. The first and second side surfaces 123 and 124 are adjacent to each other.

The space inside the housing 12 is divided into a first handling section 126 configured to perform various kinds of handling processes for recognizing and sorting the banknotes and a second handling section 127 configured to perform various kinds of handling processes for bundling the banknotes to be bundled. The second handling section 127 is provided above the first handling section 126. The first handling section 126 includes the hopper unit 2, the recognition unit 3, the non-bundling stackers 5, and the reject stacker 6. The second handling section 127 includes the bundling stackers 4, the second transport unit 8, the bundling unit 9, and the third transport unit 10. Most of the first transport unit 7 is included in the first handling section 126.

The bundling stackers 4 include two stackers; namely, a first bundling stacker 4A and a second bundling stacker 4B. Both of the first and second bundling stackers 4A and 4B stack the banknotes to be bundled. The banknotes stacked as those to be bundled are determined as appropriate. The banknotes to be bundled are banknotes of a predetermined kind. The predetermined kind is identified by denomination or the orientation of the banknotes, or by determining whether the banknotes are fit or unfit, whether the banknotes are facing up or down, or whether the banknotes are new or not, for example. In this example, the banknotes to be bundled are fit banknotes of a predetermined denomination (e.g., 100 Chinese Yuan). In the following description, the banknotes which are recognized as normal by the recognition unit 3 will be hereinafter referred to as “normal banknotes,” the banknotes which are not recognized as normal by the recognition unit 3 will be hereinafter referred to as “abnormal banknotes,” and the banknotes which are transported in an abnormal state, e.g., skewed or multi-fed, will be hereinafter referred to as “abnormally transported banknotes.” For example, one of the conditions for determining whether the banknotes are normal or not is whether the serial numbers of the banknotes are distinguishable or not. However, the normality of the banknotes may be checked based on a different condition, or an additional condition may be applied to determine whether the banknotes are normal or not. The banknotes which are determined as the normal banknotes but the destination of which (the bundling stacker, the non-bundling stacker, or other stackers) is not designated will be hereinafter referred to as “undesignated banknotes.” Among the normal banknotes, those which are not stained or torn significantly will be hereinafter referred to as “fit banknotes,” and those which are stained or torn significantly will be hereinafter referred to as “unfit banknotes.” The bundling stacker 4 is an exemplary first stacking unit.

The first and second bundling stackers 4A and 4B are substantially arranged vertically, i.e., one on top of the other, in the second handling section 127. The first bundling stacker 4A is positioned over the second bundling stacker 4B. The first and second bundling stackers 4A and 4B have the same configuration. When it is not necessary to distinguish the two stackers from each other, they will be hereinafter referred to as “bundling stackers 4.” A detailed configuration of the bundling stackers 4 will be described later.

The non-bundling stackers 5 include two stackers; namely, a first non-bundling stacker 5A and a second non-bundling stacker 5B. The first and second non-bundling stackers 5A and 5B are arranged substantially horizontally, i.e., side by side, in the first handling section 126. The second non-bundling stacker 5B is arranged closer to the hopper unit 2 than the first non-bundling stacker 5A is. When it is not necessary to distinguish the two stackers from each other, they will be hereinafter referred to as “non-bundling stackers 5.” The banknotes to be stacked in the non-bundling stackers 5 may be determined as appropriate. Here, the first non-bundling stacker 5A stacks unfit banknotes of the predetermined denomination. The second non-bundling stacker 5B stacks banknotes of every denomination but the predetermined denomination.

The reject stacker 6 stacks the rejected banknotes. The reject stacker 6 is positioned closer to the hopper unit 2 than the first and second non-bundling stackers 5A and 5B are. The reject stacker 6 is positioned at a level slightly higher than the first and second non-bundling stackers 5A and 5B. The banknotes to be stacked in the reject stacker 6 may be determined as appropriate. Here, the reject stacker 6 stacks the “undesignated banknotes,” “abnormal banknotes,” and “abnormally transported banknotes” as the rejected banknotes.

The hopper unit 2 is provided for a portion of the first side surface 123 corresponding to the first handling section 126, and the dispense unit 11 is provided in a portion of the first side surface 123 corresponding to the second handling section 127.

The hopper unit 2 includes a mount 21 on which banknotes are placed, two guides 22, 22 which guide the banknotes placed on the mount 21, intake rollers 23, an inlet 24 through which the banknotes are taken in, and a banknote sensor 25 which senses the banknotes on the mount 21. In the present embodiment, the banknotes are placed on the hopper unit 2 such that the banknotes are taken in along their shorter edges.

As shown in FIG. 1, the inlet 24 is arranged at a corner where the mount 21 and the first side surface 123 intersect with each other. The mount 21 is tilted such that the closer to the inlet 24, the lower the level of the mount 21. Thus, the banknotes on the mount 21 go toward the inlet 24 by themselves. The banknotes placed on the mount 21 are taken into the housing 12 through the inlet 24.

The banknote sensor 25 is provided near the inlet 24. The banknote sensor 25 includes a transmitter which emits light and a receiver which receives the light, and senses the banknotes when the light emitted from the transmitter toward the receiver is blocked. First and second banknote sensors 45 and 46, stacking sensors 52 and 62, tracking sensors 74, and first, second, and third tape sensors 9210, 9211 to be described later are also configured in the same manner. The banknote sensor 25 is arranged such that the light is blocked by the banknotes placed on the mount 21. That is to say, the banknote sensor 25 can sense that the banknotes are placed on the mount 21 when the light is blocked.

The guides 22, 22 are configured such that the interval between them is adjustable. Specifically, the interval between the guides 22, 22 is adjusted according to the banknotes placed on the mount 21.

The intake rollers 23 include kicker rollers 23a, feed rollers 23b, and gate rollers 23c. The kicker rollers 23a are partially exposed from the mount 21, and are in contact with the lowermost one of the banknotes placed on the mount 21. The kicker rollers 23a feed the lowermost one of the banknotes on the mount 21 to the inlet 24. Thus, the banknotes are taken in through the inlet 24 one by one. The banknotes taken in through the inlet 24 are distributed one by one by the feed rollers 23b and the gate rollers 23c into the housing 12. The banknotes thus taken in are passed to the first transport unit 7.

The dispense unit 11 includes a dispense port 111 through which the bundled banknotes are dispensed. In the dispense unit 11, the bundled banknotes are dispensed through the dispense port 111 along their shorter edges.

The first transport unit 7 may be configured as a transport belt or any other suitable member. The first transport unit 7 includes a main transport path 71, first to fourth diverged paths 72a to 72d diverged from the main transport path 71, sorting mechanisms 73 provided at junctions between the main transport path 71 and the diverged paths, and a plurality of tracking sensors 74 which sense the passage of the banknotes. The first transport unit 7 transports the banknotes along their shorter edges. The first transport unit 7 is an exemplary transport unit.

The main transport path 71 extends from the intake rollers 23 to the first bundling stacker 4A. The first diverged path 72a is the most upstream path in the main transport path 71, and the second, third, and fourth diverged paths 72b, 72c and 72d are arranged in this order downstream of the first diverged path 72a. When it is not necessary to distinguish the first to fourth diverged paths 72a to 72d from each other, they will be hereinafter referred to as “diverged paths 72.” The first diverged path 72a extends to reach the reject stacker 6. The second diverged path 72b extends to reach the second non-bundling stacker 5B. The third diverged path 72c extends to reach the first non-bundling stacker 5A. The fourth diverged path 72d extends to reach the second bundling stacker 4B.

The sorting mechanisms 73 are driven by a solenoid (not shown). Each of the sorting mechanisms 73 sorts the banknotes being transported through the main transport path 71 depending on whether they need to be diverged to an associated one of the diverged paths 72 or not. A tracking sensor 74 is provided upstream of each of the sorting mechanisms 73. The tracking sensors 74 are configured in the same manner as the banknote sensor 25. That is, the tracking sensors 74 can sense the passage of the banknotes if the reception of light by the receiver of the tracking sensor 74 is temporarily interrupted and then resumed. In guiding the banknotes to the diverged path 72, each sorting mechanism 73 is turned ON as soon as the tracking sensor 74 immediately upstream thereof senses the passage of the banknotes.

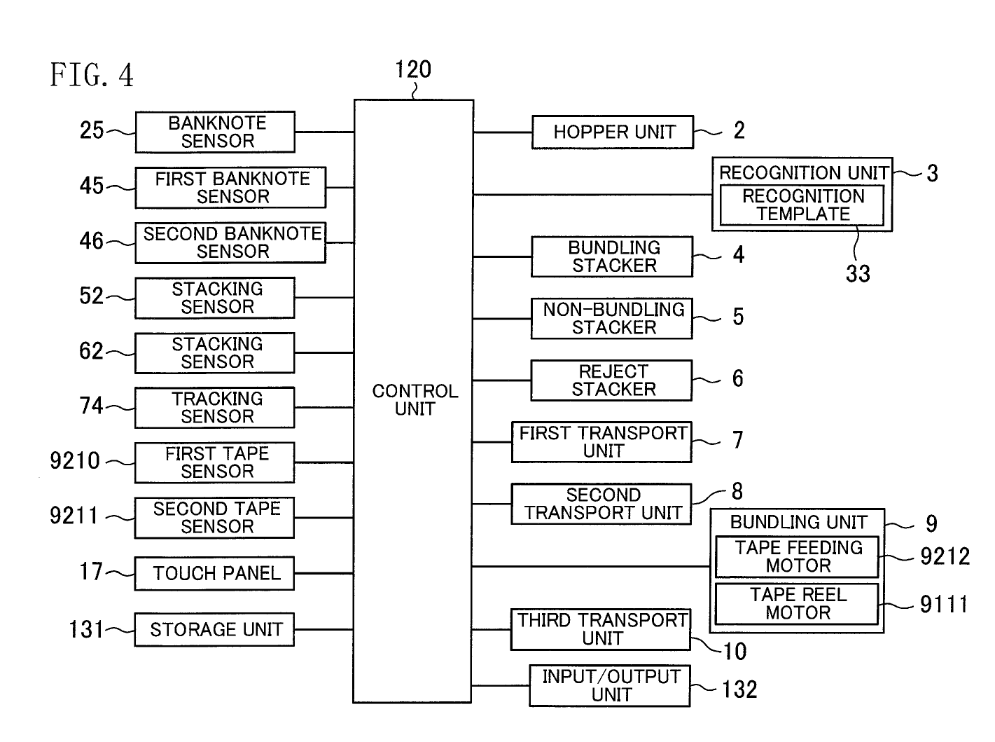

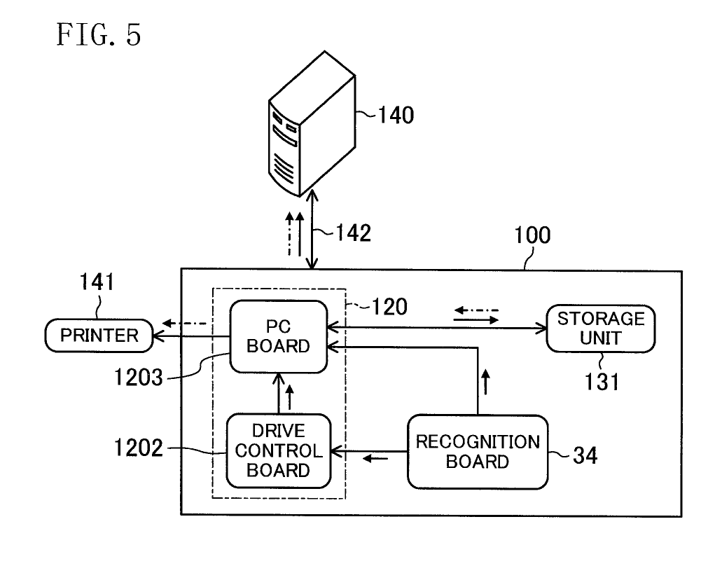

The recognition unit 3 is provided on the main transport path 71 upstream of the first diverged path 72a. The recognition unit 3 is configured to recognize each of the banknotes being transported in terms of their denomination, authentication, and fitness. The recognition unit 3 is configured as a unit within the banknote handling apparatus 100, although not shown in detail. The recognition unit 3 includes a drive control board (a recognition board 34, see FIG. 5) separately from the control unit 120 (see FIG. 4) which controls the entire banknote handling apparatus 100. This recognition board 34 includes a recognition template 33 which includes information that needs to be used to recognize the banknotes and which the recognition unit 3 refers to when recognizing the banknotes. Moreover, the recognition unit 3 includes a line sensor 31 and a magnetic sensor 32, and senses the feature of each banknote. The recognition unit 3 determines whether the feature of the banknote thus sensed corresponds with any of the features of the banknotes stored in the recognition template 33, thereby making a determination about their denomination, authentication, and fitness.

The recognition unit 3 does not always include the line sensor and the magnetic sensor, but may include any other suitable sensor such as an infrared sensor and an ultraviolet sensor as long as they can sense the features of the banknotes. The line sensor 31 also has the function of optically reading the serial numbers printed on the banknotes. How to read the serial numbers will be specifically described later. Note that a control unit 120 to be described later may have all the functions of the recognition unit 3 but the sensing function.

The bundling unit 9 bundles the stacked banknotes. As will be described in detail later, the bundling unit 9 forms a tape loop L out of a tape, and rewinds the tape after the banknotes have been transported into the tape loop L so that the banknotes are bundled with the tape.

The second transport unit 8 grips the banknotes stacked in the bundling stacker 4 to transport the banknotes into the tape loop L. The second transport unit 8 includes a gripper 81 which grips the banknotes, a first horizontal displacement mechanism which displaces the gripper 81 in the horizontal direction along the shorter edges of the banknotes (this direction will be hereinafter referred to as a “first horizontal direction”), a second horizontal displacement mechanism which displaces the gripper 81 in the horizontal direction along the longer edges of the banknotes (hereinafter referred to as a “second horizontal direction”), and a vertical displacement mechanism which displaces the gripper 81 in the vertical direction. The second transport unit 8 is an exemplary paper sheet transport unit.

The gripper 81 includes an upper arm 81a, a lower arm 81b facing the upper arm 81a, and a gripping mechanism which displaces the upper arm 81a in the vertical direction. The gripping mechanism supports the upper arm 81a so that the upper arm 81a is movable in the vertical direction, and moves the upper arm 81a in the vertical direction using a motor and a drive belt. This configuration allows the upper and lower arms 81a and 81b to grip the banknotes.

The first horizontal displacement mechanism supports the gripper 81 so that the gripper 81 is movable in the first horizontal direction, and displaces the gripper 81 in the first horizontal direction using the motor and the drive belt.

The vertical displacement mechanism supports the first horizontal displacement mechanism so that the first horizontal displacement mechanism is movable in the vertical direction, and displaces the first horizontal displacement mechanism in the vertical direction using the motor and the drive belt.

The second horizontal displacement mechanism supports the vertical displacement mechanism so that the vertical displacement mechanism is movable in the second horizontal direction, and displaces the vertical displacement mechanism in the second horizontal direction using the motor and the drive belt.

Thus, the gripper 81 is configured to be readily moved along three orthogonal axes by the first and second horizontal displacement mechanisms and the vertical displacement mechanism.

The third transport unit 10 transports the bundled banknotes to the dispense unit 11. The third transport unit 10 includes an upper gripping part 101, a lower gripping part 102, and a horizontal displacement mechanism which displaces the upper and lower gripping parts 101 and 102 in the first horizontal direction. In displacing the upper gripping part 101 in the first horizontal direction, the horizontal displacement mechanism displaces the upper gripping part 101 in the vertical direction, too. That is, the third transport unit 10 is configured to pass beside the bundling unit 9 in the first horizontal direction. When the third transport unit 10 is positioned opposite to the dispense unit 11 relative to the bundling unit 9, the upper gripping part 101 is positioned over, and sufficiently distant from, the lower gripping part 102. The upper gripping part 101 moves downward from this position as it approaches the bundled banknotes in the bundling unit 9. Then, when the upper gripping part 101 reaches the bundled banknotes, the bundled banknotes are gripped by the upper and lower gripping parts 101 and 102. The upper and lower gripping parts 101 and 102 transport the bundled banknotes to the vicinity of the dispense unit 11 while gripping them. In the vicinity of the dispense unit 11, the upper gripping part 101 moves upward as it approaches the dispense unit 11. As a result, the bundled banknotes gripped by the upper and lower gripping parts 101 and 102 are released from the upper and lower gripping parts 101 and 102 at the dispense unit 11, and are dispensed to the dispense unit 11.

On the second side surface 124 of the housing 12, as shown in FIG. 1, a touch panel 17 is provided to serve as an operating unit through which information is entered into the banknote handling apparatus 100 and as a display unit which displays information about the banknote handling apparatus 100. The touch panel 17 is a human interface for the operator who operates this banknote handling apparatus 100.

<Detailed Configuration of Bundling Stacker 4>

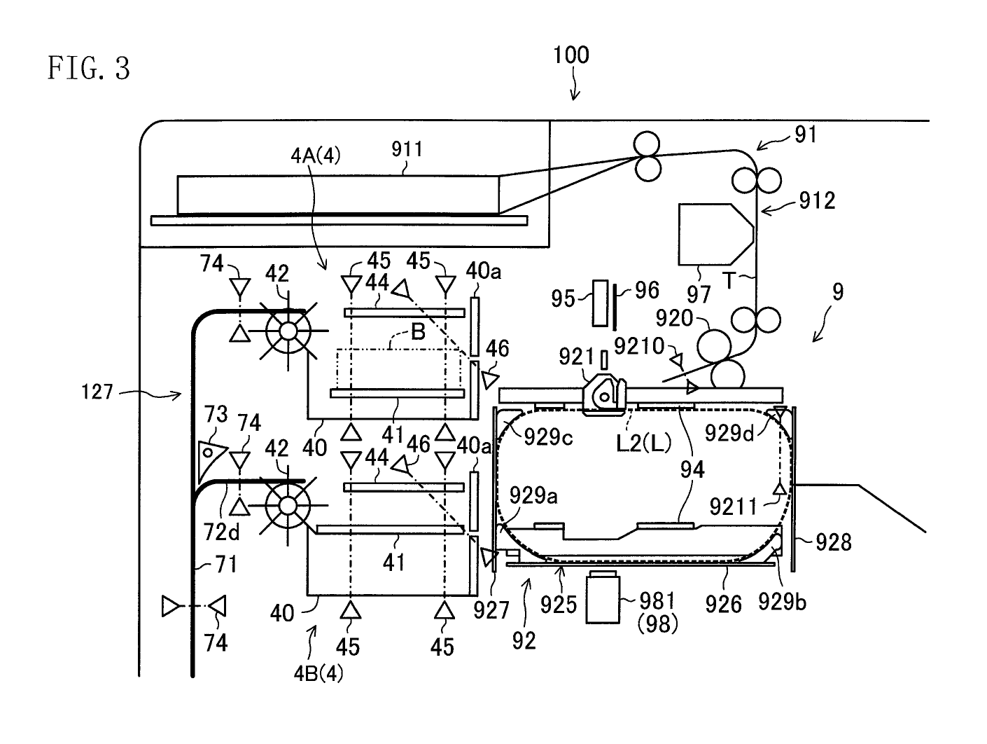

FIG. 3 illustrates a general configuration for the bundling stackers 4 and the bundling unit 9.

The bundling stackers 4 pile and stack banknotes B. As shown in FIGS. 1 to 3, each of the bundling stackers 4 includes a container 40 in which the banknotes B are stacked, a stage 41 arranged in the container 40 to carry the banknotes B thereon, a stacking wheel 42 which brings the transported banknotes B into the container 40, a door 43 which opens/closes the first outlet 47 to be described later, a top plate 44 which determines a ceiling of the container 40, a first banknote sensor 45 which senses the banknotes B in the container 40, and a second banknote sensor 46 which senses the banknotes B of a predetermined height in the container 40.

The container 40 has a front wall 40a which is located in front in the transport direction of the banknotes B and is configured to be movable forward and backward in the transport direction. The position of the front wall 40a is adjusted according to the dimension of the shorter edges of the banknotes B specified as those to be bundled. In particular, the front wall 40a is arranged such that the banknotes B brought into the container 40 collide against the front wall 40a and fall as they are to the bottom of the container 40 so as to be stacked there in contact with the front wall 40a. The front wall 40a is also configured to open/close in the vertical direction. The front wall 40a opens when the stacked banknotes B are transported by the second transport unit 8.

The stage 41 is configured to be movable in the vertical direction. For example, the stage 41 moves in the vertical direction in accordance with the amount of the banknotes B stacked.

The container 40 has an opening through the second side surface 124 of the housing 12. That is, the first outlet 47 through which the banknotes B stacked in the bundling stackers 4 are removed out of the housing 12 is provided through the second side surface 124 as shown in FIG. 1.

The door 43 is provided for each of the bundling stackers 4. The door 43 is configured to be rotatable around a predetermined rotation axis to change between an open state where the first outlet 47 is opened and a closed state where the first outlet 47 is closed, and is opened/closed manually. The door 43 is made of a material which allows for visual check of the inside of the bundling stacker from outside. For example, the door 43 may be made of a transparent or translucent material (e.g., glass or a resin).

The stacking wheel 42 includes a plurality of flexible blades, and has the function of tapping the banknotes B falling into the container 40 on their rear edges in the transport direction so as to help the banknotes B fall. Even when the banknotes B are brought into the container 40 successively, each of the banknotes B is prevented from being inserted below the rear edge of the preceding banknote B, and thus the banknotes B can be sequentially stacked one by one on top of the previously stacked ones.

Two or more banknote sensors 45 are provided for each of the bundling stackers 4. In the present embodiment, two banknote sensors 45 are provided in the container 40 at different positions in the transport direction of the banknotes B. The first banknote sensor 45 is configured in the same manner as the banknote sensor 25. Each of the banknote sensors 45 is arranged to project light in the stacking direction of the banknotes B in the container 40. That is to say, the banknote sensor 45 can sense the presence of the banknotes B in the container 40 when the light is blocked. The provision of the two banknote sensors 45 at the different positions in the transport direction enables any one of the banknote sensors 45 to sense the presence of the banknotes B even when the positions of the banknotes B vary in the transport direction in the container 40. Note that two or more banknote sensors 45 may be provided at different positions in the direction orthogonal to both of the transport and thickness directions of the banknotes B (the direction coming out of the paper of FIG. 2).

The second banknote sensor 46 is configured to sense the banknotes B located at a predetermined height in the container 40. The second banknote sensor 46 is configured in the same manner as the banknote sensor 25. The second banknote sensor 46 is arranged such that light emitted from the transmitter to the receiver is blocked by the banknotes B when the banknotes B are present at a level higher than the predetermined height, and that the light emitted from the transmitter is received by the receiver when the banknotes B are not present at the level higher than the predetermined height.

<Detailed Configuration for Bundling Unit 9>

As shown in FIG. 3, the bundling unit 9 includes a tape feeding unit 91 which feeds a tape T, a tape loop forming unit 92 which forms a tape loop L out of the tape T, a clamp 94 which presses the banknotes B in the stacking direction when the banknotes B are bundled together with the tape T, a heater 95 which heat-seals portions of the tape T wound around the banknotes B, a cutter 96 which cuts the tape T at a portion not wound around the banknotes B, a printer 97 which prints characters on the tape T, and a stamper 98 which stamps a seal on the tape T.

The tape feeding unit 91 includes a tape reel 911 around which the tape T is wound, and a tape transporter 912 which transports the tape T drawn from the tape reel 911. The tape transporter 912 transports the tape T along a predetermined transport path. The tape transporter 912 has a guide (not shown) and multiple pairs of rollers.

The tape loop forming unit 92 forms a tape loop L out of the tape T, and rewinds the tape T after the stacked banknotes B have been put into the tape loop L to wind the tape T around the banknotes B. The tape loop forming unit 92 includes a pair of feed rollers 920 which feeds and rewinds the tape T, a tape gripping part 921 which grips an end portion of the tape T, a guide 925 which defines the shape of the tape loop L being formed out of the tape T, a first tape sensor 9210 which senses the end portion of the tape T, and a second tape sensor 9211 which senses that a large tape loop L2 has been formed. Although not shown in detail, the tape loop forming unit 92 has a small tape loop formed out of the tape T by the tape gripping part 921, and then has the tape T fed by the pair of feed rollers 920 to enlarge the small tape loop L1 into a large tape loop L2. In the meantime, the guide 925 guides the tape T to define the shape of the large tape loop L2, and the second tape sensor 9211 senses that the large tape loop L2 has been formed.

The pair of feed rollers 920 is driven by a tape feeding motor 9212 (see FIG. 4), and feeds the tape T in forming the tape loop L. The pair of feed rollers 920 is located at the downstream end of the tape transporter 912, and forms part of the tape transporter 912. The pair of feed rollers 920 is an exemplary feeder. A pair of rollers of the tape transporter 912 is also driven by the tape feeding motor 9212 through a belt, a gear, or any other suitable mechanism.

Moreover, the tape reel 911 is provided with a tape reel motor 9111 (see FIG. 4) which rotates the tape reel 911 in a direction in which the tape T is rewound. When the tape T is wound around the banknotes B after having been put into the tape loop L, the tape reel motor 9111 and the tape feeding motor 9212 rotate in the tape (T) rewinding direction. Both the tape feeding motor 9212 and the tape reel motor 9111 are configured as stepping motors.

The first tape sensor 9210 is provided on the transport path of the tape T between the pair of feed rollers 920 and the tape gripping part 921. The first tape sensor 9210 is configured in the same manner as the banknote sensor 25. The first tape sensor 9210 senses the tape T when the light is cut off. For example, the first tape sensor 9210 may sense the end portion of the tape T when the light that has been cut off starts being received again by the first tape sensor 9210 as the pair of feed rollers 920 rewinds the tape T.

The tape gripping part 921 is arranged at a position where the tape gripping part 921 can receive the tape T fed from the pair of feed rollers 920. Although not shown in detail, the tape gripping part 921 rotates while gripping, at the end portion thereof, the tape T fed from the pair of feed rollers 920, thereby forming the tape loop L.

In forming the large tape loop L2, the guide 925 comes into contact with an outer peripheral surface of the large tape loop L2 to define the shape of the large tape loop L2. The guide 925 defines the shape of the large tape loop L2 to be a generally rectangular shape, more specifically, a rectangular shape having rounded corners.

The guide 925 includes a lower guide 926 which comes into contact with the outer peripheral surface of the large tape loop L2 from under the large tape loop L2, first and second lateral guides 927 and 928 which come into contact with the outer peripheral surface of the large tape loop L2 horizontally, and four corner guides, namely, first to fourth corner guides 929a to 929d, which correspond to the four corners of the rectangle.

The lower guide 926 is provided with a displacement mechanism, and is configured to be readily moved in the vertical direction by the displacement mechanism. This displacement mechanism functions as the displacement mechanism for the lower clamp that will be described later.

The first lateral guide 927 extends in the vertical direction at one of longitudinal ends of the lower guide 926 closer to the bundling stacker 4, and regulates the position of the tape T in the tape width direction.

The second lateral guide 928 extends in the vertical direction at the other longitudinal end of the lower guide 926 closer to the dispense unit 11. The second lateral guide 928 is supported to be movable up and down by the support, and is coupled to the lower guide 926 through the link. Thus, the second lateral guide 928 moves upward or downward as the lower guide 926 moves upward or downward. Note that the magnitude of movement of the second lateral guide 928 is amplified by the link. The second lateral guide 928 is configured to retreat upward during the transportation of the bundled banknotes B so as not to interfere with the transportation of the bundled banknotes B.

The second tape sensor 9211 is configured in the same manner as the banknote sensor 25, and senses the tape T when the light is cut off. The receiver of the second tape sensor 9211 is attached to the fourth corner guide 929d as shown schematically in FIG. 3. The transmitter of the second tape sensor 9211 is arranged such that the light emitted from the transmitter is cut off by the tape T guided along the fourth corner guide 929d. That is, the second tape sensor 9211 senses that the fourth corner guide 929d is guiding the tape T, i.e., the tape loop L has reached a predetermined size, when the light emitted from the transmitter is not received by the receiver.

The clamp 94 presses the banknotes B in the stacking direction when the banknotes B are bundled together with the tape T. The clamp 94 presses the banknotes B around their portion to be bundled with the tape T. The clamp 94 includes an upper clamp provided above the banknotes B transported into the tape loop L, a lower clamp provided below the banknotes B, and a displacement mechanism which allows the lower clamp to move up and down.

The lower clamp is configured to be movable up and down. In this embodiment, the lower clamp is attached to the lower guide 926 of the guide 925, and moves up and down together with lower guide 926. In other words, the displacement mechanism which displaces the lower clamp in the vertical direction functions as the displacement mechanism for the lower guide 926.

The heater 95 bonds together portions of the tape T wound around the banknotes B. The heater 95 heat-seals such portions of the tape T. The heater 95 is an exemplary bonding unit.

The cutter 96 cuts a portion of the tape T not wound around the banknotes B, that is, an extra portion of the tape T that has not been used to bundle the banknotes B together with the tape T. The cutter 96 has a saw-toothed cutting edge at its end. The cutter 96 is an exemplary cutting unit.

The heater 95 and the cutter 96 are configured as a unit, and are arranged opposite to the stamper 98 relative to the banknotes B brought into the tape loop L, that is, opposite to the stamper 98 in the stacking direction of the banknotes B. More specifically, the heater 95 and the cutter 96 are arranged above the tape gripping part 921. The heater 95 bonds the tape T on a base 922 of the tape gripping part 921. The cutter 96 cuts the tape T on the base 922 of the tape gripping part 921.

The printer 97 is arranged in the tape transporter 912 as shown in FIG. 3. The printer 97 has a printer head which prints characters on the tape T transported by the tape transporter 912. The printer 97 prints, for example, information about the banknotes B to be bundled (e.g., denomination, date, and/or serial number) on the tape T. The print made by the printer 97 is shifted in the tape width direction from a portion on which a seal will be stamped by the stamper 98 so that the print does not overlap with the seal stamped by the stamper 98.

The stamper 98 stamps a seal on the tape T wound around the banknotes B compressed by the clamp 94. The stamper 98 stamps a seal related to the banknotes B to be bundled (e.g., a seal of a financial institution, a seal indicating the kind of the banknotes such as fit or unfit notes) on the tape T. The stamper 98 is arranged opposite to the heater 95 and the cutter 96 relative to the banknotes B brought into the tape loop L, in particular, opposite to the heater 95 and the cutter 96 in the stacking direction of the banknotes B. The stamper 98 includes a stamp 981 and a displacement mechanism (not shown) which displaces the stamp 981 in the vertical direction. When the displacement mechanism displaces the stamp 981 upward, the stamp 981 stamps a seal on the tape T wound around the banknotes B in the stacking direction of the banknotes B. The stamper 98 forms an integral part of the lower guide 926, and moves up and down along with the lower guide 926 that is moving up and down.

<Configuration for Banknote Handling Apparatus>

FIG. 4 is a block diagram illustrating a general configuration for the banknote handling apparatus 100.

The banknote handling apparatus 100 includes a control unit 120 based on a well-known microcomputer, for example. The control unit 120 is connected to the above-described units, namely, the hopper unit 2, the recognition unit 3, the bundling stackers 4, the non-bundling stackers 5, the reject stacker 6, the first and second transport units 7 and 8, the bundling unit 9, the third transport unit 10, and the touch panel 17 so as to transmit and receive signals to/from these units. The control unit 120 is also connected to the banknote sensor 25, the first and second banknote sensors 45 and 46, the stacking sensors 52 and 62, the tracking sensors 74, the first and second tape sensors 9210 and 9211 to receive detection signals from these sensors. Here, the stacking sensor 52 senses the presence or absence of the banknotes on the non-bundling stackers 5, and the stacking sensor 62 senses the presence or absence of the banknotes on the reject stacker 6. The control unit 120 is further connected to a storage unit 131 which stores various kinds of information, and, as will be described later, an input/output unit 132 which inputs and outputs a signal to/from a higher-ranking device 140 and a printer 141. The control unit 120 is configured to input and output various kinds of signals between the control unit 120 itself and the storage unit 131 and the input/output unit 132. The control unit 120 generates a control signal based on the signal supplied from the touch panel 17, the detection signals from the sensors and other suitable signals, and outputs the generated control signal to the hopper unit 2 and other units. The hopper unit 2 and other units operate in accordance with the control signal. Taking the bundling stacker 4 as an example, the control unit 120 controls the front wall 40a of the container 40, the stage 41, and the stacking wheel 42.

<Working Mechanism of Banknote Handling Apparatus>

It will be described how to perform a deposit process using this banknote handling apparatus 100. In the deposit process, loose banknotes are sorted and stacked in the predetermined stackers, and predetermined ones of them are bundled. In the following description, a single kind banknote bundling process will be described, in which a predetermined number of fit banknotes of a prescribed kind to be bundled are stacked alternately in the first and second bundling stackers 4A, 4B, and the predetermined number of banknotes stacked are bundled sequentially by the bundling unit 9.

The banknote handling apparatus 100 is placed on a teller counter to be positioned on the front left side of the operator (on the front right side of a customer) when the operator faces the customer over the teller counter. At this time, the banknote handling apparatus 100 is arranged such that the first side surface 123 of the housing 12 faces the customer. In this state, the second side surface 124 of the housing 12 faces the operator. However, since the banknote handling apparatus 100 is located slightly on the front left side of the operator, the customer can also see the second side surface 124.

First, the operator receives loose banknotes to be deposited from the customer, and places the banknotes on the hopper unit 2. At this time, even if the loose banknotes include banknotes of multiple different kinds, all the banknotes are just placed on the hopper unit 2 without sorting them. The operator adjusts the guides 22 according to the dimension of the banknotes. Then, the operator operates the touch panel 17 to start the intake of the banknotes. The banknote handling apparatus 100 may automatically start the intake of the banknotes when the banknote sensor 25 senses the banknotes placed on the hopper unit 2.

The banknotes placed on the hopper unit 2 are brought into the housing 12 one by one through the inlet 24 as the intake rollers 23 are activated. The banknotes thus taken in are transported by the first transport unit 7, and pass through the recognition unit 3. The recognition unit 3 senses the kind of the banknotes passed, and informs the control unit 120 of the kind of the banknotes. Furthermore, the recognition unit 3 reads the serial numbers of the banknotes, and informs the control unit 120 of the serial numbers, too.

The control unit 120 designates the banknotes' destination according to the kind of the banknotes. In particular, if the banknotes are fit banknotes of a predetermined denomination to be bundled, the control unit 120 designates the bundling stacker 4 (any one of the bundling stackers 4A and 4B) as their destination. If the banknotes are unfit banknotes of the predetermined denomination to be bundled, the control unit 120 designates the first non-bundling stacker 5A as their destination. If the banknotes are of any denomination other than the predetermined denomination, the control unit 120 designates the second non-bundling stacker 5B as their destination. If the banknotes are rejected banknotes, the control unit 120 designates the reject stacker 6 as their destination.

The control unit 120 controls the first transport unit 7 such that the banknotes are transported to the stacker designated as their destination. In particular, the control unit 120 controls the sorting mechanism 73 corresponding to the diverged path 72 leading to the destination stacker such that the banknotes are guided from the main transport path 71 to the diverged path 72. The control unit 120 switches the sorting mechanism 73 when the tracking sensor 74 just before the diverged path 72 senses the banknotes. Thus, the control unit 120 has the banknotes transported to the destination stacker.

The banknotes to be transported to the bundling stacker 4 are transported to one of the two bundling stackers 4. When the number of banknotes stacked in one of the bundling stackers 4 reaches a predetermined bundling number (e.g., 100), the remaining banknotes are then transported to the other bundling stacker 4. In this example, the banknotes are supposed to be transported to the first bundling stacker 4A first. When the banknotes are transported one after another to the first bundling stacker 4A, the stacking wheel 42 rotates to stack the banknotes one by one. At this time, when the uppermost one of the banknotes on the stage 41 is sensed by the second banknote sensor 46, the stage 41 moves downward to a predetermined degree so that the second banknote sensor 46 does not sense any banknotes. Then, when the banknotes are further stacked much enough for the second banknote sensor 46 to sense the banknotes, the stage 41 then moves downward again to the predetermined degree. Performing this series of processing steps a number of times allows for keeping the distance for the banknotes falling into the bundling stacker 4 to travel within a predetermined range, thus enabling the banknotes falling freely to be stacked at the same position and with the same orientation.

When the number of banknotes stacked in the first bundling stacker 4A reaches the bundling number, the control unit 120 controls the second transport unit 8 so that the banknotes in the first bundling stacker 4A are gripped by the gripper 81 and transported to the bundling unit 9. Then, the control unit 120 controls the bundling unit 9 so that the banknotes are bundled with the tape T.

When the number of banknotes stacked in the first bundling stacker 4A reaches the bundling number, the remaining banknotes are stacked in the second bundling stacker 4B. Then, when the number of banknotes stacked in the second bundling stacker 4B reaches the bundling number, the remaining banknotes are stacked again in the first bundling stacker 4A. By this time, the banknotes have already been transported from the first bundling stacker 4A, and thus the first bundling stacker 4A is now empty. Thus, the provision of the two bundling stackers 4 allows for performing the bundling process while stacking the banknotes continuously.

Subsequently, the control unit 120 controls the third transport unit 10 so that the bundled banknotes are dispensed through the dispense port 111.

The unfit banknotes of the predetermined denomination are transported to, and stacked in, the first non-bundling stacker 5A. Likewise, the banknotes of any denominations other than the predetermined denomination are transported to, and stacked in, the second non-bundling stacker 5B. The rejected banknotes are also transported to, and stacked in, the reject stacker 6.

This series of processing steps will be performed over and over again until there are no banknotes placed on the hopper unit 2. The banknote sensor 25 determines whether banknotes are still present on the hopper unit 2 or not.

When the handling of the banknotes placed on the hopper unit 2 is finished, the rejected banknotes are taken in and recognized again. Specifically, the operator extracts the rejected banknotes from the reject stacker 6, and places them on the hopper unit 2 to take them into the apparatus again. The rejected banknotes are those which were not recognized as normal banknotes for any reason, and thus another attempt is made to take in and recognize them. Banknotes still recognized as rejected banknotes, if any, are restacked in the reject stacker 6. Then, the operator returns those restacked banknotes to the customer.

Note that the banknotes stacked in the first and second non-bundling stackers 5A, 5B are not taken in again.

Thus, when the handling of the banknotes placed on the hopper unit 2 and the re-handling of the rejected banknotes are finished, the single kind banknote bundling process is finished, i.e., the counting and sorting of the banknotes passed as those to be deposited by the customer are finished. The touch panel 17 displays the counted amount of the banknotes. The operator asks for a customer's approval of the amount, or checks whether the displayed amount corresponds with the amount described on a deposit slip by the customer, and, if the answer is YES, the operator operates the touch panel 17 to confirm the deposit amount. When the confirmation is done, the higher-ranking device 140 (see FIG. 5) is informed of the confirmed deposit amount, thereby finishing the deposit process.

After the deposit process is finished, the operator removes the bundled banknotes stacked in the dispense unit 11, the banknotes stacked in the bundling stackers 4, and the banknotes stacked in the non-bundling stackers 5, and stores them in a predetermined storage place.

By performing this series of processing steps, loose banknotes of different kinds are sorted into fit banknotes of a predetermined denomination, unfit banknotes of the predetermined denomination, banknotes of every denomination but the predetermined denomination, and rejected banknotes. The fit banknotes of the predetermined denomination are bundled on a bundling number basis.

<Process for Managing and Saving Serial Number>

FIG. 5 illustrates an exemplary configuration for a banknote handling system including the banknote handling apparatus 100 described above. This banknote handling apparatus 100 is connected to a higher-ranking device 140 either wirelessly or via a communications line 142. The communications line 142 here includes a network such as a local area network (LAN) or a wide area network (WAN). In addition, a printer 141 for printing also is connected to the banknote handling apparatus 100. The printer 141 may also be connected to the banknote handling apparatus 100 via a network. As described before, the banknote handling apparatus 100 includes the storage unit 131. In this embodiment, in particular, the storage unit 131 stores the read serial number of a recognized banknote in association with a banknote-related image. This will be described later in detail. The storage unit 131 may be configured as a hard disk drive having a magnetic disk, a solid state drive (SSD) having a flash memory, or any of various memory cards such as a secure digital (SD) card. The storage unit 131 may also be configured as a so-called “external storage device” which is connected removably to the body of the banknote handling apparatus 100. This allows for replacing the storage unit 131 with another storage unit 131 when the storage capacity of the storage unit 131 runs out.

As described before, the banknote handling apparatus 100 includes the control unit 120. Specifically, this control unit 120 includes a drive control board 1202, and a PC board 1203. The drive control board 1202 mainly controls hardware parts of the banknote handling apparatus 100 in terms of the transportation of the banknotes, for example. The PC board 1203 mainly controls software parts of the banknote handling apparatus 100 in terms of presentation on and manipulation of the touch panel 17 and storage and output of a serial number to be described later. As described before, the recognition unit 3 includes the recognition board 34 that is different from the drive control board 1202 and the PC board 1203. The recognition board 34 is connected to each of the drive control board 1202 and the PC board 1203. As will be described later, the recognition board 34 provides these boards 1202 and 1203 with recognition information, and information and data on a serial number. The drive control board 1202 provides the PC board 1203 with information on a banknote. The PC board 1203 provides the storage unit 131 with information. The PC board 1203 also provides the printer 141 and the higher-ranking device 140 with information via the input/output unit 132. As will be described later, the recognition board 34 may also be configured to directly provide the higher-ranking device 140 with information, not through the PC board 1203.

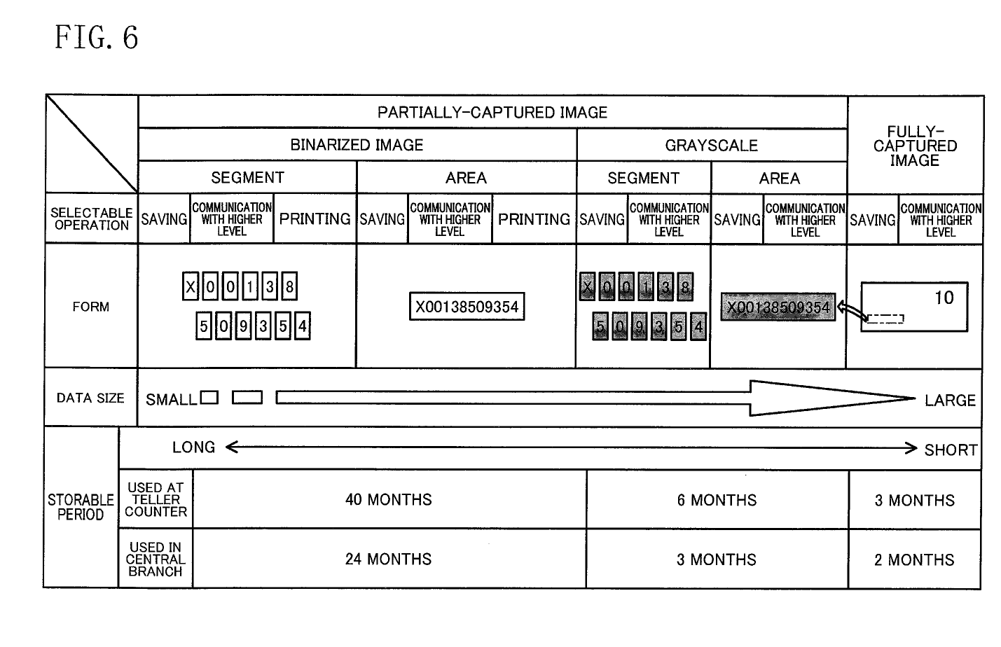

As described before, the recognition unit 3 not only recognizes a banknote but also reads its serial number. The serial number is read based on a full image of the banknote obtained by the line sensor 31. Specifically, as illustrated in FIG. 6, the line sensor 31 obtains a full image (i.e., a fully-captured image) of a banknote being transported. The fully-captured image is a grayscale image having predetermined tone levels. The tone levels of the fully-captured image may be changed in the banknote handling apparatus 100. Although not shown, the user selects either 256 tone levels or 16 tone levels on a setting screen displayed on the touch panel 17. The user may set the tone levels of the fully-captured image at any arbitrary timing during the initialization when the banknote handling apparatus 100 is installed. Thus, the user may obtain a full image having his or her desired tone levels. The touch panel 17 and the control unit 120 form an exemplary tone level setting unit.

After obtaining the fully-captured image, the recognition unit 3 determines the printed position of the serial number on the banknote, based on the fully-captured image and information about the kind of the banknote obtained from the result of the recognition. Note that the information about the printed position of the serial number with respect to each denomination is stored in the recognition template 33. Based on the printed position of the serial number thus determined, the recognition unit 3 crops a predetermined area, including the printed position, out of the fully-captured image to generate an area image. The area image thus generated has the predetermined tone levels (i.e., a grayscale). In this case, in the banknote handling apparatus 100, the tone levels of the area image may be changed as long as they are lower than those of the fully-captured image. The user selects either 256 tone levels or 16 tone levels as those for the area image on a setting screen (not shown) displayed on the touch panel 17. The user may set the tone levels of the area image at any arbitrary timing during the initialization when the banknote handling apparatus 100 is installed, as in the case of the fully-captured image described above.

After generating the grayscale area image, the recognition unit 3 binarizes the area image. Moreover, the recognition unit 3 crops segments included in the serial number out of the binarized area image on a character-by-character basis, thereby generating binarized segment images. The area image and the segment images will be sometimes hereinafter referred to as “partially-captured images” collectively.

When the binarized segment images are generated, the recognition unit 3 performs optical character recognition (OCR) processing on the binarized segment images. By performing this OCR processing, each of the characters is recognized and the serial number printed on the banknote is read. The recognition unit 3 is an example of an image processing unit, an area image generation unit, a binarized segment image generation unit, a binarized area image generation unit, and an OCR unit.

Note that, in the foregoing description, the recognition unit 3 obtains or generates the four kinds of images in total; namely, the full image (i.e., the fully-captured image) and the grayscale area image, binarized area image, and binarized segment images, all of which have been generated by processing the full image. Other than the four kinds of images, the recognition unit 3 may generate grayscale segment images based on the grayscale area image. In that case, the recognition unit 3 is to obtain or generate five kinds of images in total.

Furthermore, in the foregoing description, the recognition unit 3 sequentially processes the full image, the grayscale area image, the binarized area image, and the binarized segment images in this order. However, the recognition unit 3 may also generate the binarized area image based on the full image by cropping a predetermined area out of the full image and binarizing the area substantially simultaneously. That is to say, the image processing order (i.e., processing steps) described above is only an example. Thus, it is possible to change the order of the processing steps, omit one or more processing steps, add one or more processing steps, or replace one or more processing steps with another processing step.

Moreover, in the foregoing description, the recognition unit 3 eventually generates the binarized segment images based on the full image, under the assumption that the recognition unit 3 performs OCR processing on the binarized segment images. Thus, the generation of the binarized segment images may be omitted if the OCR processing is performed on a different kind of image, instead of the binarized segment images.

In this manner, obtained are the five kinds of images in total; namely, the full image of a banknote, and at least one processed image generated by processing this full image (up to four kinds of images including the grayscale area image, the grayscale segment images, the binarized area image, and the binarized segment images in the example described above). Described below is processing for recording the serial number under the assumption that the four kinds of images—the full image, the grayscale area image, the binarized area image, and the binarized segment image—are obtained or generated.

As a form of the management of serial numbers, the banknote handling apparatus 100 stores, in the storage unit 131, the read serial number in association with an image selected by the user from these four kinds of images. In this case, as illustrated in FIG. 6, the four kinds (or five kinds) of images have mutually different data sizes. Specifically, the data size decreases in the order of the full image, the grayscale area image, the grayscale segment images, the binarized area image, and the binarized segment images. As a result, under the assumption that the storage capacity of the storage unit 131 remains the same, the storage unit 131 may store images the largest number of images if the images to store are binarized segment images; in contrast, the storage unit 131 may only store the smallest number of images if the images to store are full images. For example, if this banknote handling apparatus 100 is used at a teller window of a financial institution branch such as a bank, an exemplary amount of information storable in this apparatus covers approximately forty months as for binarized partially-captured images, approximately six months as fro partially-captured grayscale images, or approximately three months as for fully-captured images. Meanwhile, if this banknote handling apparatus 100 is used at a central branch which handles a larger number of banknotes than the branch does, an exemplary amount of information storable in this apparatus covers approximately twenty-four months as for binarized partially-captured images, approximately three months as for partially-captured grayscale images, and approximately two months as for fully-captured images.

This banknote handling apparatus 100 allows the user to select the way of recording a banknote-related image. Specifically, the banknote handling apparatus 100 allows the user to select one or more of the following options: have the storage unit 131 store a banknote image in association with its serial number (i.e., saving); have the higher-ranking device 140 store the banknote image in association with its serial number (i.e., communicating with the higher-ranking device); and have the printer 141 print the banknote image on a sheet of paper (i.e., printing). This banknote handling apparatus 100 also allows the user to select the kind of image to be recorded. In this embodiment, as illustrated in FIG. 6, he or she is allowed to select either saving or communicating with the higher-ranking device as for the fully-captured image and the partially-captured grayscale images. On the other hand, he or she is allowed to select one of saving, communicating with the higher-ranking device and printing as for the binarized partially-captured images.

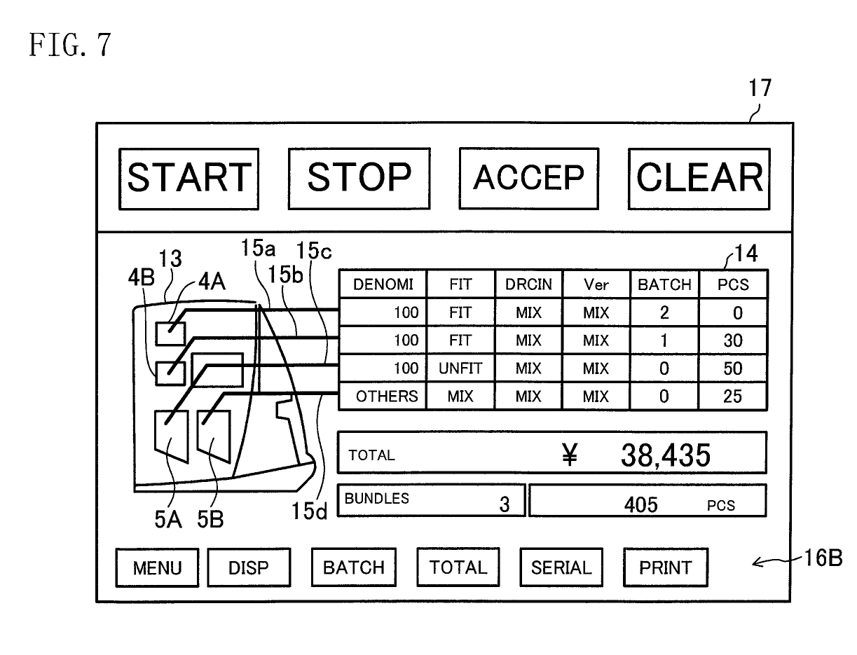

The touch panel 17 of the banknote handling apparatus 100 displays a setting screen which allows the user to make various settings on recording an image under the control of the control unit 120. Described next with reference to FIGS. 7 to 10 is how to make settings on recording a banknote image. Note that all of the on-screen images shown in FIGS. 7 to 10 are only examples.

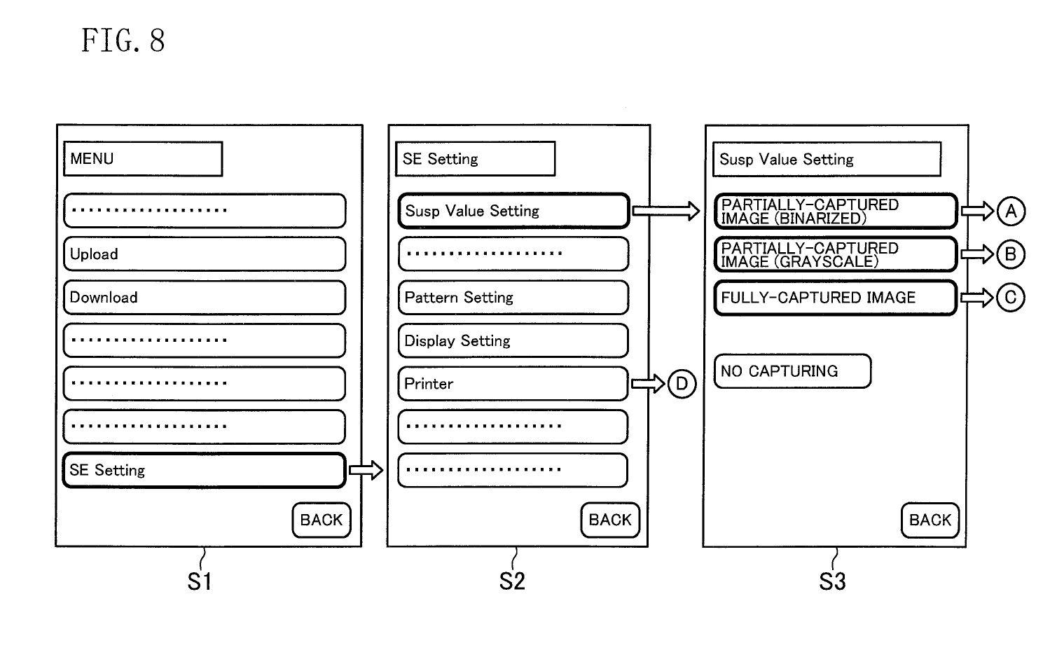

FIG. 7 illustrates an exemplary on-screen image displayed on the touch panel 17 of the banknote handling apparatus 100 in operation. At the bottom 16B of this on-screen image, displayed are various selection buttons. When the user selectively presses a “MENU” button from these selection buttons, the touch panel 17 displays a menu screen S1 illustrated in FIG. 8.

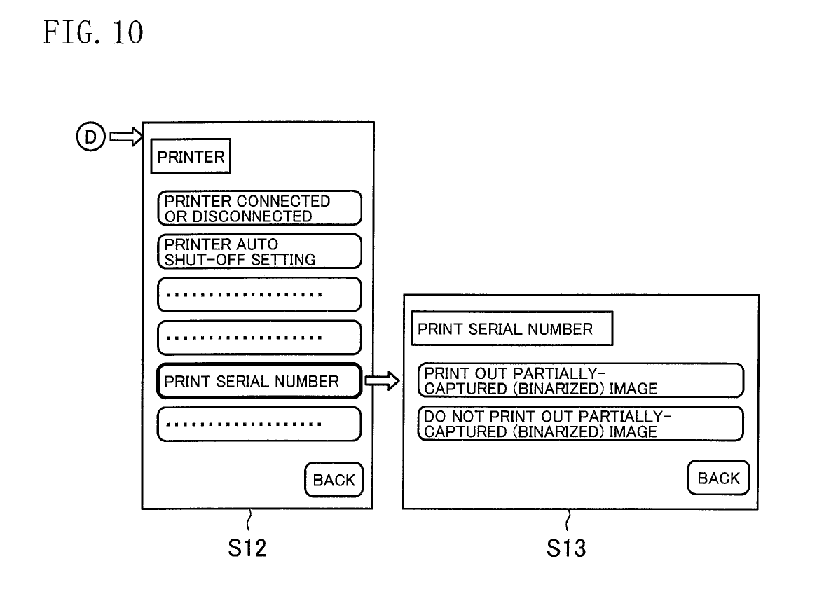

On the menu screen S1, multiple menu buttons are arranged. Note that, in the example illustrated in FIG. 8, some menu buttons are hidden and indicated by dots. The same can be said about FIG. 10 to be referred to later. If the user selectively presses an “SE setting” button from these menu buttons, the touch panel 17 displays an SE setting screen S2. The SE setting screen S2 includes multiple setting buttons. If the user selectively presses “recognition setting (Susp Value Setting)” from these setting buttons, the touch panel 17 displays a susp value setting screen S3.

The susp value setting screen S3 includes four buttons; namely, “Partially-Captured Image (Binarized),” “Partially-Captured Image (Grayscale),” “Fully-Captured Image,” and “No Capturing.” The “Partially-Captured Image (Binarized)” is a button allowing the user to make settings on recording a binarized partially-captured image. The “Partially-Captured Image (Grayscale)” is a button allowing the user to make settings on recording a partially-captured grayscale image. The “Fully-Captured Image” is a button allowing the user to make settings on recording a fully-captured image. Furthermore, if the user selectively presses the “No Capturing” button, none of those images are to be recorded by the banknote handling apparatus 100, and the touch panel 17 then displays the menu screen S1.

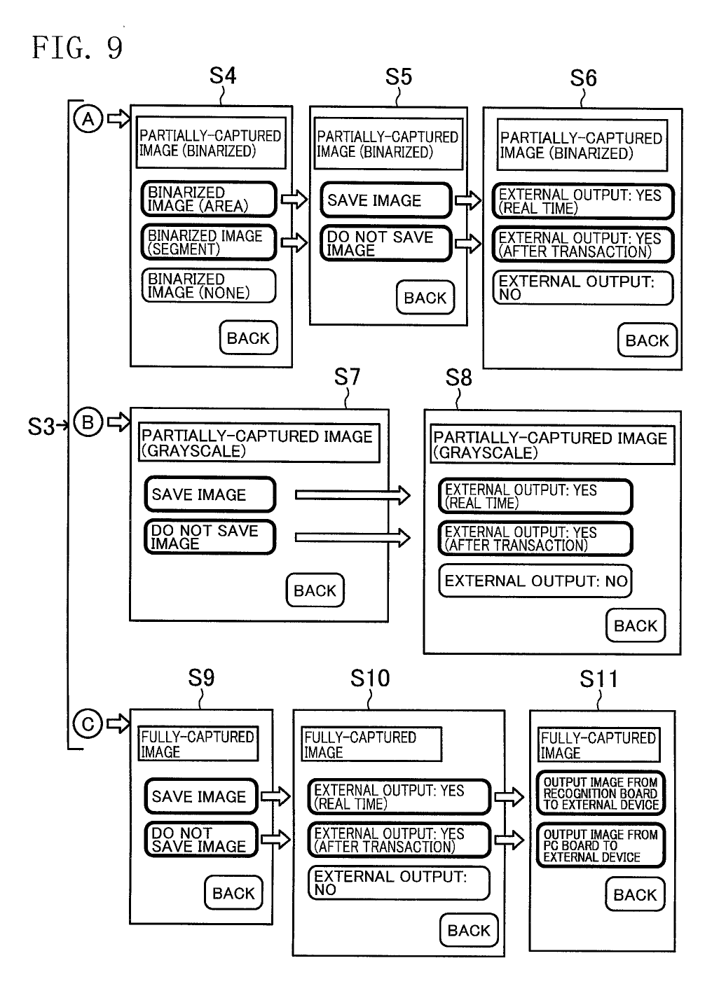

If the user selectively presses the “Partially-Captured Image (Binarized)” button on the susp value setting screen S3, the touch panel 17 displays the partially-captured image (binarized) setting screen S4 shown in FIG. 9. This setting screen S4 includes three buttons; namely, “Binarized Image (Area),” “Binarized Image (Segments),” and “Binarized Image (None).” If the user selects the “Binarized Image (None)” button from these three buttons, the banknote handling apparatus 100 does not store the binarized partially-captured image (i.e., including both of the area image and the segment image). The touch panel 17 then displays the susp value setting screen S3.

On the other hand, if the user selects either the “Binarized Image (Area)” button or the “Binarized Image (Segments)” button, the touch panel 17 displays the setting screen S5 coming next. This setting screen S5 includes two selection buttons; namely, “Save Image” and “Do Not Save Image.” If the user selectively presses the “Save Image” button, the banknote handling apparatus 100 stores, in the storage unit 131, either the binarized area image or the binarized segment images in association with the serial number as will be described later. If the user selectively presses the “Do Not Save Image” button, the banknote handling apparatus 100 stores neither the binarized area image nor the binarized segment images.

No matter whether the user selects the “Save Image” button or the “Do Not Save Image” button on the setting screen S5, the touch panel 17 then displays a setting screen S6 asking about output to an external device; in other words, an output to the higher-ranking device 140. This setting screen S6 includes three selection buttons; namely, “Output Image to External Device (Real Time),” “Output Image to External Device (After Transaction),” and “Do Not Output Image to External Device.” If the user selects the “Output Image to External Device (Real Time)” button from these selection buttons, the banknote handling apparatus 100 outputs the binarized partially-captured image to the higher-ranking device 140 while executing the deposit transaction related processing; that is, while sequentially transporting the banknotes, obtaining a full image of each of the banknotes, and generating each processed image and reading the serial number, as described before. On the other hand, if the user selects the “Output Image to External Device (After Transaction)” button, the banknote handling apparatus 100 outputs the binarized partially-captured image to the higher-ranking device 140 after the deposit transaction related processing ends. This will be described later. Instead, if the user selects the “Do Not Output Image to External Device” button, the banknote handling apparatus 100 does not output the binarized partially-captured image to the higher-ranking device 140.

On the other hand, if the user selectively presses the “Partially-Captured Image (Grayscale)” button on the susp value setting screen S3, the touch panel 17 displays the partially-captured image (grayscale) setting screen S7 illustrated in FIG. 9. Just like the setting screen S5 described before, this setting screen S7 also includes two selection buttons; namely, “Save Image” and “Do Not Save Image.” If the user selectively presses the “Save Image” button, the banknote handling apparatus 100 stores a grayscale area image in the storage unit 131 in association with the serial number. If the user selectively presses the “Do Not Save Image” button, the banknote handling apparatus 100 does not store the grayscale area image. No matter whether the user selects the “Save Image” button or the “Do Not Save Image” button on the setting screen S7, the touch panel 17 then displays a setting screen S8 asking about output to an external device. Just like the setting screen S6 described before, this setting screen S8 also includes three selection buttons; namely, “Output Image to External Device (Real Time),” “Output Image to External Device (After Transaction),” and “Do Not Output Image to External Device.” If the user selects the “Output Image to External Device (Real Time)” button, the banknote handling apparatus 100 outputs a grayscale partially-captured image to the higher-ranking device 140 while executing the deposit transaction related processing. On the other hand, if the user selects the “Output Image to External Device (After Transaction)” button, the banknote handling apparatus 100 outputs the grayscale partially-captured image to the higher-ranking device 140 after the deposit transaction related processing ends. Moreover, if the user selects the “Do Not Output Image to External Device” button, the banknote handling apparatus 100 does not output the grayscale partially-captured image to the higher-ranking device 140.

Furthermore, if the user selectively presses the “Fully-Captured Image” button on the susp value setting screen S3, the touch panel 17 displays the fully-captured image setting screen S9 as illustrated in FIG. 9. Just like the setting screen S5 described before, this setting screen S9 also includes two selection buttons; namely, “Save Image” and “Do Not Save Image.” If the user selectively presses the “Save Image” button, the banknote handling apparatus 100 stores a full image in the storage unit 131 in association with the serial number. If the user selectively presses the “Do Not Save Image” button, the banknote handling apparatus 100 does not store the full image. After displaying the setting screen S9, the touch panel 17 displays a setting screen S10 asking about output to an external device. Just like the setting screen S6 described before, this setting screen S10 includes three selection buttons; namely, “Output Image to External Device (Real Time),” “Output Image to External Device (After Transaction),” and “Do Not Output Image to External Device.” If the user selects the “Output Image to External Device (Real Time)” button, the banknote handling apparatus 100 outputs the full image to the higher-ranking device 140 while executing the deposit transaction related processing. On the other hand, if the user selects the “Output Image to External Device (After Transaction)” button, the banknote handling apparatus 100 outputs the full image to the higher-ranking device 140 after the deposit transaction related processing ends. Instead, if the user selects the “Do Not Output Image to External Device” button, the banknote handling apparatus 100 does not output the full image to the higher-ranking device 140.

If the user chooses to output the image to an external device on the setting screen S10, the touch panel 17 displays the setting screen S11 coming next. This setting screen S11 relates to processing executed when the full image is output to the higher-ranking device 140. As described before, the full image has a relatively large data size, and the processing load on the banknote handling apparatus 100 increases. In particular, when the full image needs to be output in real time, the overall processing load on the banknote handling apparatus 100 may be significantly heavy, since the banknote handling apparatus 100 is also executing other types of processing besides outputting the full image. Thus, regarding outputting the full image to an external device, the user may select, on the setting screen S11, either the option of “Output Image from Recognition Board to External Device” or the option of “Output Image from PC Board to External Device.” The user selects either the “Output Image from Recognition Board to External Device” button or the “Output Image from PC Substrate to External Device” button.

In this manner, on the susp value setting screen S3 described before, the user is allowed to set separately the necessity for storing, in the storage unit 131, each of the binarized partially-captured images, the grayscale partially-captured images, and the fully-captured image. Thus, the user may select and save any arbitrary one or more of the binarized segment images, the binarized area image, the grayscale area image, and the full image.

FIG. 10 illustrates an exemplary printer setting screen S12 allowing the user to make settings on the printout of an image. This printer setting image S12 is displayed on the touch panel 17 when the user selects the “Printer” button on the SE setting screen illustrated in FIG. 8.

If the user selects the “Print Serial Number” button from multiple selection buttons included in the printer setting screen S12, the touch panel 17 displays the serial number print setting screen S13 coming next. This serial number print setting screen S13 is for setting whether the binarized partially-captured image is printed by the printer 141, and includes a “Print Out Partially-Captured (Binarized) Image” button and a “Do Not Print Out Partially-Captured (Binarized) Image” button. If the user selectively presses the “Print Out Partially-Captured (Binarized) Image” button, the printer 141 is set to print out the image. On the other hand, if the user selectively presses the “Do Not Print Out Partially-Captured (Binarized) Image” button, the printer 141 is set not to print out the image.

In this manner, the user is allowed to set the following necessities for recording banknote image: whether or not the image needs to be stored in the storage unit 131, and if the answer is YES, the kind of the image to be stored; whether or not the image needs to be output to the higher-ranking device 140, and if the answer is YES, the kind of image to be output and the timing of output; and whether or not the image needs to be output to the printer 141. The touch panel 17 and the control unit 120 are examples of an option setting unit, an option presentation unit, and an output setting unit.

Described next with reference to FIG. 5 is how the banknote handling apparatus 100 operates in recording the serial number during a deposit transaction. While performing the deposit transaction related processing, the recognition unit 3 (the recognition board 34) recognizes each of the banknotes and obtains information on the banknote, as described before. In addition, the recognition unit 3 obtains a full image of the banknote, and gets its serial number through the image processing and the OCR processing. As indicated by the solid arrows in FIG. 5, the recognition board 34 provides each of the drive control board 1202 and the PC board 1203 with information on the banknote such as its serial number. Furthermore, the recognition board 34 provides the PC board 1203 with an image selected by the user as the one to be recorded, which may be the full image, the grayscale area image, the binarized area image, and the binarized segment image. The user chooses to store the image in the storage unit 131, output the image to the higher-ranking device 140, and/or output the image to the printer 141.

The drive control board 1202 provides the PC board 1203 with information on a banknote that has been once recognized as a normal banknote by the recognition unit 3 but has later turned out to be a rejected banknote during the transportation due to some problem such as transportation error. The PC board 1203 determines the banknote to be deposited in accordance with the banknote information provided by both the recognition board 34 and the drive control board 1202. Moreover, the PC board 1203 outputs, to the storage unit 131, the image selected by the user, as well as the serial number of the banknote to be deposited. In response, the storage unit 131 stores the image of the banknote in association with its serial number.

If the option of outputting the selected image in real time to the higher-ranking device 140 as an external device has been set, the PC board 1203 outputs the image selected by the user together with the serial number to the external device during the deposit transaction related processing (as indicated by the solid line arrows in FIG. 5). The image output in such a manner is stored in the higher-ranking device 140 along with the serial number. Note that if the user selects the full image, the recognition board 34, not the PC board 1203, may output the selected full image to the higher-ranking device 140 as an external device.

If the printout option has been set, the PC board 1203 automatically reads the binarized partially-captured image from the storage unit 131 and outputs the read image to the printer 141 (as indicated by the one-dot-chain arrows in FIG. 5) as soon as the user performs either a predetermined start operation after the deposit transaction has ended, or a transaction end operation on the banknote handling apparatus 100. The printer 141 prints out the binarized partially-captured image.

Moreover, if the option set is outputting the selected image to the higher-ranking device 140 as an external device after the transaction has ended, the PC board 1203 outputs the image read from the storage unit 131 together with the serial number to the external device (as indicated by the one-dot-chain arrows in FIG. 5).

Thus, the banknote handling apparatus 100 with such a configuration allows the user to select any arbitrary kind of image to be stored in the storage unit 131 in association with the serial number. Consequently, the banknote handling apparatus 100 allows for dealing flexibly with the user's requests.

Moreover, the banknote handling apparatus 100 may output an image selected by the user to the higher-ranking device 140 at his or her request, and have the higher-ranking device 140 store the output image. The banknote handling apparatus 100 may also have the selected image printed out on a sheet of paper by the printer 141. In this manner, the banknote handling apparatus 100 allows for recording the banknote-related image in various forms.

Furthermore, the user may decide whether he or she wants to output the image to the higher-ranking device 140 in real time during the deposit transaction related processing or after the transaction ends. This enables avoiding imposing a heavy processing load on the banknote handling apparatus 100.

Note that the configuration described above allows the user to set the necessities for (i) storing an image in the storage unit 131 and (ii) outputting the image to the higher-ranking device 140 as an external device with respect to all of the four kinds of images including the full image and the at least one processed image. However, the configuration described above may be modified so as to allow the user to set the necessities for (i) storing an image in the storage unit 131 and (ii) outputting the image to the higher-ranking device 140 as an external device, only for three or two kinds of images selected from the four kinds of images. For example, the configuration may be modified so as to allow the user to set the necessities for (i) storing an image in the storage unit 131 and (ii) outputting the image to the higher-ranking device 140 as an external device, only for the fully-captured image and a binarized partially-captured image (i.e., the area image and/or the segment images). Alternatively, for example, the configuration may also be modified so as to allow the user to set the necessities for (i) storing an image in the storage unit 131 and (ii) outputting the image to the higher-ranking device 140 as an external device, only for the partially-captured grayscale image and the binarized partially-captured image. Reducing the number of options to be selected by the user enables the user to make his or her selection more easily and improves the handiness of the banknote handling apparatus 100. Note that the options to be selected by the user become fewer than the kinds of images obtained or generated by the banknote handling apparatus 100.

### DESCRIPTION OF REFERENCE CHARACTERS

12 Housing
17 Touch Panel (Option Presentation Unit, Output Setting Unit, and Tone level Setting Unit)
100 Banknote Handling Apparatus
120 Control Unit (Option Setting Unit, Option Presentation Unit, Output Setting Unit, and Tone level Setting Unit)
131 Storage Unit
132 Input/Output Unit (Output Unit)
140 Higher-Ranking Device
141 Printer
3 Recognition Unit (Full Image Obtaining Unit, Image Processing Unit, Area Image Generation Unit, Binarized Segment Image Generation Unit, Binarized Area Image Generation Unit, and OCR Processing Unit)
31 Line Sensor
34 Recognition Board
7 First Transport Unit (Transport Unit)
B Banknote

1. A banknote handling system comprising:
a transport unit configured to transport a banknote one by one;
a full image obtaining unit configured to obtain a full image of the banknote being transported by the transport unit;
an image processing unit configured to process the full image obtained by the full image obtaining unit to generate at least one processed image smaller in data size than the full image;
an option presentation unit configured to present a user with a plurality of options and allow the user to select one of the plurality of options, the options including the full image and the at least one processed image; and
a storage unit configured to store an image related to the option selected by the user from the plurality of options presented by the option presentation unit.

2. The banknote handling system of claim 1, wherein
the image processing unit includes at least:
an area image generation unit configured to generate an area image cropped out of the full image of the banknote and representing an area of the banknote on which a serial number is printed; and
a binarized segment image generation unit configured to generate binarized segment images by cropping segments representing characters included in the serial number on a character-by-character basis and by binarizing the segments,
the banknote handling system further comprises an option setting unit configured to set the plurality of options selected from the full image, the area image, and the binarized segment images, and
the option presentation unit presents the user with the plurality of options set by the option setting unit.

3. The banknote handling system of claim 2, wherein
the image processing unit further includes a binarized area image generation unit configured to binarize the area image, and
the binarized segment image generation unit crops the binarized segment images out of the binarized area image.

4. The banknote handling system of claim 2, further comprising
an optical character recognition (OCR) processing unit configured to perform OCR processing on the binarized segment images to get the serial number, wherein
the storage unit stores the serial number in association with the image related to the option selected by the user.

5. The banknote handling system of claim 1, further comprising
an output unit configured to output the image related to the option selected by the user from the plurality of options presented by the option presentation unit.

6. The banknote handling system of claim 4, wherein
the transport unit sequentially transports a plurality of banknotes,
an output unit outputs the image either during, or after, the transportation of the plurality of banknotes, and
the banknote handling system further comprises an output setting unit configured to allow the user to set timing of the output of the output unit.

7. The banknote handling system of claim 1, wherein
the storage unit is configured to be detachable from and attachable to a body of the banknote handling system including at least the transport unit and the full image obtaining unit.

8. The banknote handling system of claim 1, wherein
the full image obtaining unit is capable of changing a tone level of the full image to be obtained, and
the banknote handling system further comprises a tone level setting unit configured to allow the user to set the tone level of the full image.

9. The banknote handling system of claim 2, wherein
the area image generation unit is capable of changing a tone level of the area image to be generated, and
the banknote handling system further comprises a tone level setting unit configured to allow the user to set the tone level of the area image.

10. A banknote handling apparatus comprising:
a transport unit configured to transport a banknote one by one;
a full image obtaining unit configured to obtain a full image of the banknote being transported by the transport unit;
an image processing unit configured to process the full image obtained by the full image obtaining unit to generate at least one processed image smaller in data size than the full image;
an option presentation unit configured to present a user with a plurality of options and allow the user to select one of the plurality of options, the options including the full image and the at least one processed image;
a storage unit configured to store an image related to the option selected by the user from the plurality of options presented by the option presentation unit; and
a housing configured to house at least the transport unit, the full image obtaining unit, the image processing unit, and the option presentation unit.

11. A banknote handling method comprising:
transporting a banknote one by one;
obtaining a full image of the banknote being transported;
processing the full image obtained to generate at least one processed image smaller in data size than the full image;
presenting a user with a plurality of options and allowing the user to select one from the options before, during, or after transporting the banknote, the options including the full image and the at least one processed image; and
storing an image related to the option selected by the user from the plurality of options.
